(19) United States
(12) Patent Application Publication
(10) Pub. No.: US 2015/0176399 A1
(43) Pub. Date: Jun. 25, 2015

(54) METHOD AND APPARATUS FOR ACOUSTICAL POWER TRANSFER AND COMMUNICATION

(71) Applicant: RENSSELAER POLYTECHNIC INSTITUTE, Troy, NY (US)

(72) Inventors: Henry A. Scarton, Troy, NY (US); Gary J. Saulnier, East Greenbush, NY (US); Kyle R. Wilt, Sand Lake, NY (US)

(73) Assignee: RENSSELAER POLYTECHNIC INSTITUTE, Troy, NY (US)

(21) Appl. No.: 14/417,327

(22) PCT Filed: Aug. 22, 2013
(86) PCT No.: PCT/US2013/056143

§ 371 Date: Jan. 26, 2015

Related U.S. Application Data
(60) Provisional application No. 61/693,366, filed on Aug. 27, 2012.
(60) Provisional application No. 61/693,370, filed on Aug. 27, 2012.

(51) Int. Cl. E21B 47/16; G01V 11/00

(52) U.S. Cl. CPC E21B 47/16; G01V 11/002

(57) ABSTRACT

Systems and methods for transmitting power and information using acoustic energy are provided. The systems have particular application for powering and communication with electronics through drilling and pipe systems. An acoustic fiber having a core region radially surrounded by a cladding region is used to transmit acoustic power and signals between paired transducers. Pairs of acoustic wedges are provided for sending energy and information through a substrate. Each wedge has an angled transducer which can be used to produce angled longitudinal waves which, upon reaching a substrate interface, produce shear waves in the substrate. The shear waves propagate down the substrate and are received by a second acoustic wedge. The shear waves in the substrate transition back to longitudinal waves on reaching the second acoustic wedge, and they are converted back into electrical signals by a second transducer.

### FIELD AND BACKGROUND OF THE INVENTION

The present invention relates generally to the field of acoustics, and in particular to transducers, to communication and power transmission using vibrations, and to taking sensor readings in deep wells.

A transducer is a device that converts a signal in one form of energy to another form of energy. This can include electrical energy, mechanical energy, electromagnetic and light energy, chemical energy, acoustic energy, and thermal energy, among others. While the term “transducer” often refers to a sensor or a detector, any device which converts energy can be considered a transducer.

Transducers are often used in measuring instruments. A sensor is used to detect a parameter in one form and report it in another form of energy, typically as an electrical signal. For example, a pressure sensor might detect pressure—a mechanical form of energy—and convert it to electricity for display for transmission, recording, and/or at a remote location. A vibration powered generator is a type of transducer that converts kinetic energy derived from ambient vibration to electrical energy.

A transducer can also be an actuator which accepts energy and produces movement, such as vibrational energy or acoustic energy. The energy supplied to an actuator might be electrical or mechanical, such as pneumatic or hydraulic energy. An electric motor and a loudspeaker are both actuators, converting electrical energy into motion for different purposes.

Some transducers have multiple functions, both detecting and creating action. For example, a typical ultrasonic transducer switches back and forth many times a second between acting as an actuator to produce ultrasonic waves', and acting as a sensor to detect ultrasonic waves and converting them into electrical signals. Analogously, rotating a DC electric motor's rotor will produce electricity, and voice-coil speakers can also function as microphones.

Piezoelectric materials can be used as transducers to harvest even low levels of mechanical energy and convert them into electrical energy. This energy can be suitable for powering wireless sensors, low power microprocessors, or charging batteries. A piezoelectric sensor or transducer is a device that uses a piezoelectric effect to measure pressure, acceleration, strain, or force by converting those physical energies into an electrical charge. The piezoelectric effect is a reversible process in that materials exhibiting the direct piezoelectric effect—generation of an electrical charge as a result of an applied mechanical force—also exhibit the reverse piezoelectric effect—generating a mechanical movement when exposed to an electrical charge or field. Thus, piezoelectric transducers can also work in reverse, turning electrical energy into physical vibrational energy and vice versa. Piezoelectric transducers have the dual advantages of working using low energy levels, and at a small physical size. Ultrasonic transducers may be piezoelectric transducers, applying ultrasound waves into a body, and also receiving a returned wave from the body and converting it into an electrical signal.

Ultrasonic transducers have been implemented with great success as sensors. U.S. Pat. No. 8,210,046 teaches a damper for an ultrasonic transducer mounted on a wedge body. Ultrasonic probes having phased array transducers inject acoustic waves into an object under test at an oblique angle to inspect the test object for flaws or defects. When the oblique angle is larger than the first critical angle, according to Snell's Law, the longitudinal waves will disappear, and only the newly converted shear waves will propagate in the object under test. A wedge with an angle larger than the first critical angle is usually attached to the transducer to generate shear waves in objects under test. Shear wave ultrasonic probes typically have a wedge body connected to the ultrasonic transducers on an angled surface relative to the wedge body surface that will contact an object under test, and a damping wedge fit over the front side of the wedge body opposite the transducers.

U.S. Pat. No. 3,542,150 describes an apparatus for gathering information about the earth surrounding a borehole using the device inside the borehole. Acoustic transducers are mounted at an angle with regard to the wall of the borehole wall or axis, and the traducers are mounted in a fluid coupling medium.

U.S. Pat. No. 4,454,767 teaches an ultrasonic metering device having two ultrasonic transducers mounted on wedges on opposite sides of the thickness of a pipe to measure the flow of fluid through that section of pipe.

In drilling and oil well operations, it is often necessary to communicate information (such as sensor data) along a drill pipe string. A drill pipe string consists of connected segments of piping. Often, portions of the well and drill string are not directly accessible via a direct electrical connection. For example, there may be segments that are disjointed and sealed off from each other, making electrical connection between the segments impossible. Since it is desirable to obtain data from deep within wells, passage of the data through these obstacles is a significant issue.

Transducers have been applied for communication between one another along oil wells and other boreholes. U.S. Patent 2011/0205080 describes communicating along a borehole by placing transducers on the borehole tubing, and sending acoustical signals between the transducers along the tubing itself. The receiver transducer operates on battery power. U.S. Patent No. 2011/0176387 describes a bi-directional acoustic telemetry system for communicating data and control signals between modems along a tubing. The system includes a communication channel defined by the tubing material using a transducer at each model. There is still a need for improved systems, however. Known prior art systems for communicating along pipes and similar surface channels using transducers do not, for example, make advantageous use of pairs of angled transducers spaced at a distance along a pipe to produce and receive angled longitudinal waves which are converted into shear waves on arrival at the pipe/channel for travel through the pipe/channel.

Acoustic waveguide technology is also known. See: U.S. Pat. No. 4,894,806 assigned to Canadian Patents & Development Ltd., for: Ultrasonic imaging system using bundle of acoustic waveguides; U.S. Pat. No. 4,929,050 to Unisys Corporation, for: Traveling wave fiber optic interferometric sensor and method of polarization poling fiber optic; U.S. Pat. No. 5,217,018 to Hewlett-Packard Company, for: Acoustic transmission through cladded core waveguide; U.S. Pat. No. 5,241,287 to National Research Council of Canada, for: Acoustic waveguides having a varying velocity distribution with reduced trailing echoes; U.S. Pat. No. 5,400,788 to Hewlett-Packard, for: Apparatus that generates acoustic signals at discrete multiple frequencies and that couples acoustic signals into a cladded-core acoustic waveguide; U.S. Pat. No. 5,606,297 to Novax Industries Corporation, for: Conical ultrasound waveguide; U.S. Pat. No. 5,828,274 to National Research Council of Canada, for: Clad ultrasonic waveguides with reduced trailing echoes; U.S. Pat. No. 6,217,530 to University of Washington, for: Ultrasonic applicator for medical applications; U.S. Pat. No. 6,500,133 to University of Washington, for: Apparatus and method for producing high intensity focused ultrasonic energy for medical applications; U.S. Pat. No. 6,666,835 to University of Washington, for: Self-cooled ultrasonic applicator for medical applications; U.S. Pat. No. 7,021,145 to Horiba Instruments, Inc., for: Acoustic transducer; U.S. Pat. No. 7,062,972 to Horiba Instruments, Inc., for: Acoustic transducer; U.S. Pat. No. 7,124,621 to Horiba Instruments, Inc., for: Acoustic flowmeter calibration method; U.S. Pat. No. 7,745,521 to Ultra-Scan Corporation, for: Acoustic waveguide plate; U.S. Pat. No. 7,745,522 to Ultra-Scan Corporation, for: Acoustic waveguide plate with nonsolid cores; U.S. Pat. No. 8,119,709 to Ultra-Scan Corporation, for: Acoustic waveguide array; U.S. Pat. No. 5,400,788 to Hewlett-Packard, for: Apparatus that generates Acoustic signals at discrete multiple frequencies and that couples acoustic signals into a cladded core acoustic waveguide; U.S. Pat. No. 4,742,318 to Canadians and Dev. Ltd., for: Birefringent single-mode acoustic fiber; U.S. Pat. No. 4,743,870 to Canadian and Dev. Ltd., for: Longitudinal Mode Fiber Acoustice Waveguide with solid core and solid cladding; and U.S. Pat. No. 5,828,274 to Nat. Res. Council of Can., for: Clad Ultrasonic waveguides with reduced trailing echoes.

### SUMMARY OF THE INVENTION

It is an object of the present invention to provide improved methods and arrangements for transmitting power and signals using acoustical waves. In particular, improved methods of transmitting power and signals from the surface into oil wells and other underground locations which can be difficult to reach using prior art arrangements.

Accordingly, one preferred method and arrangement for powering, controlling, and communicating with sensors at a distance uses acoustic wave energy. The arrangement comprises a transmission arrangement comprising an acoustic signal generator, a receiving arraignment comprising an acoustic signal receiver, a least one sensor which is electrically coupled to the signal receiver, and a waveguide spanning between and engaged to the signal generator and the signal receiver. An acoustical wave preferably comprising a control signal can be generated with the signal generator, the acoustical wave preferably having sufficient strength to provide operating power to the sensor. The acoustical wave is transmitted from the signal generator to the signal receiver through the waveguide. The acoustical wave is received at the signal receiver, and converted into an electrical current optionally comprising a converted control signal. Preferably the electrical current is used to power a sensor, communication device and/or other devices in the vicinity of the receiving arrangement. A control signal can simultaneously or alternatively be transmitted by the above method, such as by modulating the acoustic wave.

The signal generator and receiver may be a transducer such as a piezoelectric transducer, may be a magnetorestrictive deice, may be a transponder or other device for creating waves in liquids, or may be another device now known or In a later invented.

In a preferred embodiment the waveguide comprises a core region, and a cladding region radially surrounding the core region and having a different material composition than the core region. The core may comprise steel wire, and the cladding may comprise aluminum. Preferably the longitudinal wave velocity of the cladding is greater than the longitudinal wave velocity of the core.

Preferably during transmission of the acoustical wave from the signal generator to the signal receiver through the waveguide, the acoustical wave substantially reflects off of the wave guide cladding to thereby substantially maintain the acoustical wave in the core.

In one embodiment the transmitting and receiving arrangements comprise piezoelectric transducers, and the signal generator piezoelectric transducer generates an acoustical wave comprising a control signal in response to electrical current applied to it. The signal receiver piezoelectric transducer then receives at least part of the acoustical wave, and converts at least a portion of the received acoustical wave into an electrical current which is then used to power and/or control the sensor. The sensor is not limited to any one sensor, and may detect pressure, temperature, vibrations, sounds, light, or other conditions.

It is possible to power one or more sensors exclusively using electricity generated by the signal receiver piezoelectric transducer, particularly sensors with low power requirements.

The signal generator and/or the signal receiver comprise a magnetorestrictive element.

In one useful configuration, the transmission arrangement is above ground, while the receiving arraignment and the sensor are below ground, such as in a mine, well, tunnel, or shaft. Acoustical waves transmitted from the signal generator to the signal receiver through the waveguide can be used to power and control the sensor below ground.

The acoustical wave is modulated in a variety of known ways to create the control signal. In a preferred embodiment a continuous wave for transmitting power is selectively modulated when it is desired to send signals or information in addition or instead of operating power.

Fluid filled waveguides comprising a liquid core region radially surrounded by solid cladding can be used with this invention. The acoustical wave can propagate through the liquid core region of the waveguide.

A method of transmitting at least one of power and signals along a substrate using angle beam probes, the method comprising:

providing a transmitting acoustic wedge 40 and a receiving acoustic wedge 50 spaced apart on a substrate 60 and coupled to the substrate at respective interfaces 48,58;

wherein each acoustic wedge 40,50 comprises a transition wedge 44,54 and a transducer 41,51 comprising a transducer face 47,57, wherein the transducer is coupled to the transition wedge, and wherein a transducer face 47,57 of each transducer is normal to an angle θ with regard to the substrate 60 at the respective interface 48,58;

wherein the transducer face 47 of the transmitting transducer 41 of the transmitting acoustic wedge 40 is normal to an angle θ₁ with respect to the respective interface 48 with the substrate 60, the angle θ₁ being between first and second critical angles such that longitudinal waves produced by the transmitting transducer 41 are substantially converted into shear waves in the substrate;

the method further comprising producing longitudinal waves 70 at angle θ₁ at the transmitting transducer 41;

the longitudinal waves 70 producing substantially only shear waves 75 in the substrate 60, and the shear waves 75 propagating through the substrate until reaching the interface 58 between the substrate and the receiving acoustic wedge 50;

energy from the shear waves providing acoustical wave energy which reaches the receiving transducer 51 of the receiving acoustic wedge 50; and

the receiving transducer 51 converting at least a portion of said acoustical wave energy into electrical energy.

In an alternative aspect of the invention, shear waves created by angled longitudinal waves can be used to send power and/or signals down the length of a substrate such as a steel pipe in an oil well.

A method and arrangement for transmitting at least one of power and signals along a substrate using angle beam probes is provided. A transmitting acoustic wedge and a receiving acoustic wedge are provided spaced apart on a substrate and coupled to the substrate at respective interfaces. In one embodiment each acoustic wedge comprises a transition wedge and a transducer comprising a transducer face. The transducer is coupled to the transition wedge, and a transducer face of each transducer is normal to an angle θ with regard to the substrate at the respective interface. A preferably planar transducer face of the transmitting transducer of the transmitting acoustic wedge is normal to an angle θ₁ with respect to the respective interface with the substrate, the angle θ₁ being between first and second critical angles such that longitudinal waves produced by the transmitting transducer are substantially converted into shear waves in the substrate.

The method further method includes producing longitudinal waves at angle θ₁ at the transmitting transducer. the longitudinal waves ideally produce only or substantially only shear waves in the substrate, and the shear waves propagate through the substrate until reaching the interface between the substrate and the receiving acoustic wedge. Energy from the shear waves provides acoustical wave energy which reaches the receiving transducer of the receiving acoustic wedge, and the receiving transducer converts at least a portion of said acoustical wave energy into electrical energy. The energy can be used to transmit power and/or signals to sensors or other electronics. This is particularly useful for sensors and electronics deep underground.

Preferably most or all of the shear wave energy which reaches the receiving acoustic wedge converts back to longitudinal waves at the receiving acoustic wedge. The receiving transducer of the receiving acoustic wedge then receives at least a portion of the longitudinal waves and converts at least a portion of said longitudinal waves into electrical energy.

The arrangement and method is not limited to particular shapes or materials. In a preferred embodiment, the substrate comprises metal(s) such as steel, and the transition wedges that can be acrylic. The substrate may be a metal pipe, such as in an oil well.

In one embodiment, the method and apparatus can also be used to send signals in the reverse direction from the receiving acoustic wedge to the transmitting acoustic wedge. The step of sending signals in the reverse direction comprises the receiving transducer generating longitudinal waves at an angle with respect to the respective interface with the substrate, the angle being between first and second critical angles such that longitudinal waves produced by the receiving transducer are substantially converted into shear waves in the substrate, and the shear waves propagating through the substrate to the receiving acoustic wedge.

In another aspect of the invention, the transition wedge of the transmitting acoustic wedge includes a generally slanted edge which is normal to an angle θ₁ with respect to the respective interface with the substrate. Typically a flat or planer face of a transducer is fixed to the slanted edge so that the transducer face is oriented in the same direction, i.e. on the same plane, as the slanted edge. In practice, the orientation of the transducer will often be selected by selecting a proper angle for the slanted edge. Thus, preferably, the slanted edge is normal to an angle θ₁ is between first and second critical angles such that longitudinal waves produced by the transmitting transducer are substantially converted into shear waves in the substrate.

Though the substrate may be a large item with a large surface area and varied shape, the angle of the substrate where the respective acoustic wedges and transducers are located is the angle of concern in selecting longitudinal wave angles. Typically this will be the angle at an interface between each acoustic wedge and the substrate.

Proper angles for launching longitudinal waves to produce shear waves in the substrate can be determined using Snell's law. The angle θ₁ between first and second critical angles can be the longitudinal wave launch angle θ_{1Longitudinal}. Thus, the method of the invention can include the step of comprising the step of determining θ_{1Longitudinal} using the relationship:

$$arcsin ( \frac{{V}_{1 Longitudinal}}{{V}_{2 Longitudinal}} ) < {θ}_{1 Longitudinal} < arcsin ( \frac{{V}_{1 Longitudinal}}{{V}_{2 Shear}} )$$

wherein V_{1Longitudinal} is the longitudinal wave speed in the transition wedge, V_{2Longitudinal} is the longitudinal wave speed in the substrate, and V₂ₛₕₑₐᵣ is the shear wave speed of the substrate. This is a method for determining the angle and orientation of the transducers and/or slanted edges supporting the transducers.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic diagram of an acoustic fiber communication power transfer system;

FIG. 2 is a top perspective view of various aluminum clad steel wires including a cross sectional view of the end;

FIG. 3 is a is a top perspective view of single and bundled aluminum clad steel wire arrangements including cross sectional views of the end;

FIG. 4 is a schematic diagram of two acoustic wedges arranged on a pipe substrate for transmitting wave energy for powering sensors;

FIG. 5 is a diagram showing reflection and refraction of waves reaching a water to air interface at various angles;

FIG. 6 is a graph and diagrams showing the relationship between the incident angle of a wave, and the type of waves produced when such waves reach a steel substrate;

FIG. 7 is a top, side, perspective, closeup view of an acoustic wedge comprising a transducer mounted on a pipe substrate;

FIG. 8 is a top front perspective view of two acoustic wedges comprising transducers mounted along a steel pipe substrate;

FIG. 9 shows pressure in a beam and wedge during shear wave propagation.

FIG. 10 shows stress in a beam and wedge during shear wave propagation;

FIG. 11 shows pressure in a beam and wedge during shear wave propagation at 0.5 MHz;

FIG. 12 shows pressure in a beam and wedge during shear wave propagation at 1.0 MHz; and

FIG. 13 shows pressure in a beam and wedge during shear wave propagation at 2.25 MHz.

### DESCRIPTION OF THE PREFERRED EMBODIMENTS

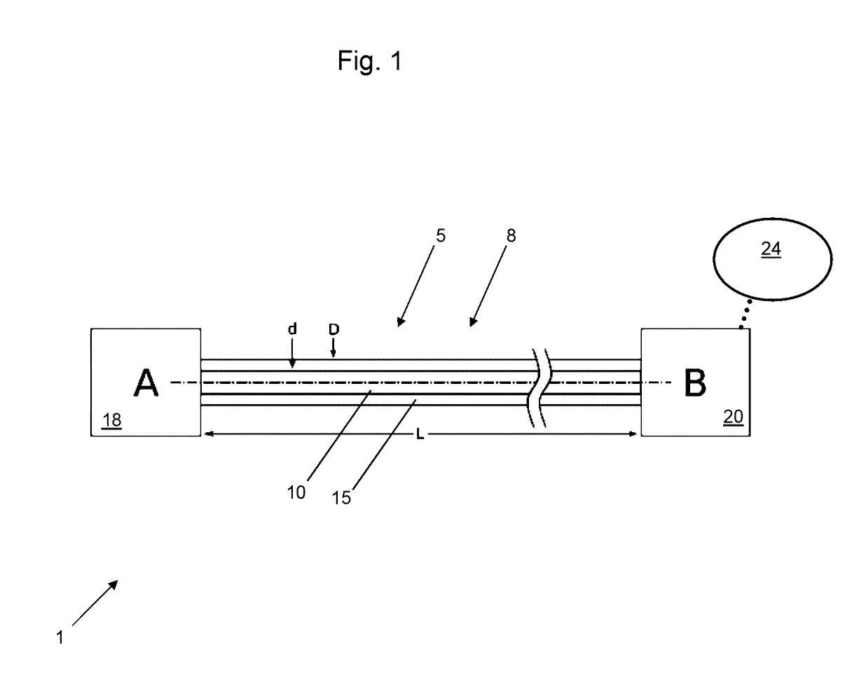

Referring now to the drawings, in which like reference numerals are used to refer to the same or similar elements, FIG. 1 schematically shows a preferred acoustic fiber 5 communication and power harvesting/transmission system 1 of the invention.

The instant invention provides a system 1 that can simultaneously transmit both digital information and power through acoustic fiber 5 using ultrasound. The fiber 5 can consist of an elastic waveguide 8 for propagating acoustic waves constructed of an elongated solid core region 10, and an elongated solid outer cladding region 15. Preferably transducers 18,20 for sending and receiving energy and/or signals are provided at two or more ends of the acoustic fiber 5.

### Acoustic Fiber Wave Guides

Broadly, a waveguide 8 is a structure that guides waves, such as electromagnetic waves or sound waves. Different types of waveguides are best suited for different types of waves. One illustrative example of a waveguide is a hollow conductive metal pipe used to carry waves such as high frequency radio waves, but many other waveguides are, of course, also possible.

Waves in open space propagate in all directions, as spherical waves. Imagine, illustratively, the circular ripples produced by dropping a pebble in a pond. As a result, waves in open space lose their power proportionally to the square of the distance. For example, at a distance R from a wave source, the power is the source power divided by R². A waveguide, under ideal theoretical conditions, confines a wave to propagation in just one dimension, so that the wave does not dissipate and lose power while propagating. Conductors used in waveguides have small skin depth and hence large surface resistance. Waves are confined inside a waveguide due to total (in theory) reflection from the waveguide wall, so that the propagation inside the waveguide can be approximated as a “zigzag” between the waveguide walls. This description is most accurate in the case of electromagnetic waves in a hollow metal tube with a rectangular or circular cross-section.

The geometry of a waveguide influences and is influenced by its function. Slab waveguides allow for two dimensions, while fiber and channel waveguides confine energy to travel only in one dimension. The frequency of the wave to be transmitted also relates to the shape of a suitable waveguide. For example, an optical fiber suitable for guiding high-frequency light is not well suited to guide microwaves, which have a much lower frequency and greater wavelength. Very generally, the width of a waveguide should preferably be of the same order of magnitude as the wavelength of the wave being guided.

### Power and Signal Transmission Through an Acoustic Fiber Waveguide

While acoustic fibers have been used for waveguides in the past, the successful application of acoustic fiber waveguides for power transduction and communication, by creating an acoustic-electric channel, is believed to be new.

Referring again to FIG. 1, in the instant acoustic fiber 5 communication and power transmission system, acoustic waves propagate in a longitudinal fashion. That is, the principle particle displacement of the waves is substantially parallel to the wave traveling direction, which in this case is the longitudinal axis of the waveguide 8 between the transducers 18, 20. This propagation axis may be straight or wandering, according to the path of the fiber 5 or other waveguide. The bulk longitudinal wave velocity in the cladding region 15 is greater than that of the core region 10, which promotes reflection of the wave off of the cladding to maintain it within the core. For example, in a preferred embodiment using aluminum cladding 15 on a steel wire core 10, the ratio of the longitudinal wave speeds of aluminum and steel (VAI/Vsteel) is 1.091, which is an acceptable ratio for use with the invention.

The communication system 1 in its simplest form is composed of a primary acoustic wave sender/receiver 18 through which the wire could pass, an acoustic fiber wire 5 extending for the necessary distance, and a secondary acoustic wave receiver/sender 20. The acoustic wave sender/receivers may be embodied as magnetostrictive couplers or piezoelectric couplers, but other embodiments and other transducers are within the scope of the invention. The sender/receivers 18,20 preferably can each turn electrical energy into acoustic wave energy, and conversely change acoustic wave energy back into electrical energy.

In a preferred embodiment the secondary acoustic wave receiver/sender 20 is associated with one or more sensors in a remote location, such as deep within an oil well, and both sender/receivers comprise transducers such as piezoelectric transducers. The primary transducer 18 is used to transmit power, and optionally also signals, to the secondary transducer 20 using sufficiently strong acoustic waves sent through an acoustic fiber 5 which functions as a waveguide 8. The secondary transducer 20 receives the acoustic waves and converts at least a portion of the acoustic wave energy into electrical energy. This energy can then be used for various functions at the remote location such as operating sensors, and generating signals which can, in turn, be sent back to the primary transducer 18 or elsewhere.

In different embodiments various sensors and circuitry will be attached to the one or more secondary receivers/senders 20 at one or more locations. The invention is not limited to a particular arrangement of sensors and/or circuitry. Once sensors associated with a secondary receiver/sender 20 are excited, resulting data can be converted to an acoustic signal that is then be transmitted back along the waveguide fiber 5 from secondary 20 to primary 18, the data being reconstructed from the received signal at or near the primary sender/receiver 18. Data from sensors can, alternatively, be sent back to the vicinity of the primary sender/receiver 18 by other means, and/or can be sent to an entirely different location.

The system and method preferably allow for wireless bi-directional transmission of information and, more preferably, for simultaneous uni-directional transmission of power through a solid acoustic waveguide using ultrasound.

A preferred waveguide for use with the invention comprises aluminum-clad steel wire, although other combinations, typically of metals, are possible.

For both power delivery and data communication, acoustic-electric transmission channels 22 can be formed by exciting the waveguide 8 at one end with piezoelectric transducers (primary 18) configured to induce longitudinal vibrations. Other methods, such as magnetorestrictive acoustic transducers, can also be used. The acoustic-electric transmission channel also comprises another transducer (secondary 20) at the other end of the wave guide shown in FIG. 1, which receives the longitudinal vibrations sent through the channel and converts them to electrical energy as a power source and/or for communication.

The direction of power transmission is generally defined as the “forward” direction. Forward power transmission, and data transmission in the opposite (reverse) direction, can be accomplished by using the combined system. Forward data transmission, in the same direction as the power transmission, can also be implemented, such as by modulating the power signal.

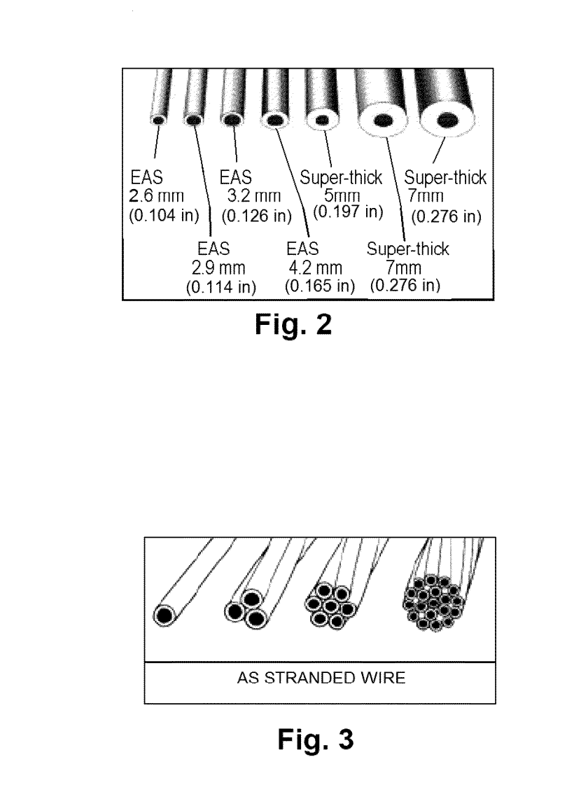

Acoustic ultrasonic power can be generated at a primary sender/receiver 18 (arrangement also labeled A in FIG. 1) via a primary transducer. The resulting wave is propagated down the acoustic wire 5, the wire having a core 10 diameter d, a cladding 15 diameter D, and length L. L can be arbitrarily long, and may be thousands of feet, such as for use in oil well applications. Aluminum-clad wire is readily available, with examples shown in FIGS. 2 and 3. Common commercially available sizes, shown to 7 mm in cladding diameter, are shown in FIG. 2. Other arrangements for simultaneous use of multiple acoustic wires and channels are also possible, as shown in FIG. 3.

An acoustic signal, having passed through the acoustic fiber 5, can be at least partially converted back to an electrical signal by rectification of the voltage produced by reception of the waves at B (secondary transducer 20), located at distance L away from the primary transducer 18 at A. Electricity produced at the secondary receiver/sender 20 can be used to power sensors, e.g., pressure and/or temperature sensors. The electrical power can also be used to transmit a modulated acoustic signal back towards the primary transducer 18 (at A) using the secondary transducer (at B) via either the same 5 or a different acoustic fiber 5 or other waveguide 8. Upon reception of the acoustic signal at the primary sender receiver 18 (A), the acoustic signal can be translated into an electrical signal, and the data contained within the acoustic signal is extracted.

Many different modulation techniques are suitable for communication using the acoustic-electric channel of this invention. Examples include traditional single-carrier modulations such as, for example, amplitude modulation (AM), frequency modulation (FM), ON-OFF Keying (OOK), amplitude-shift keying (ASK), phase-shift keying (PSK), differential phase-shift keying (DPSK), frequency-shift keying (FSK) and quadrature amplitude modulation (QAM). Multi-carrier modulations such as orthogonal frequency-division multiplexing can also be used and will, in general, provide higher data rates for this channel. Multi-carrier techniques offer the ability to optimize the transmission for the specific transfer function that the channel presents though the use of bit loading, in which each subcarrier uses a modulation type that provides the highest data rate given the signal-to-noise ratio (SNR) of that particular subcarrier channel, and/or power loading, in which the transmit power of each subcarrier is also adjusted to optimize the data throughput over all subcarriers given an overall power budget. Multi-carrier systems could be implemented using multiple fiber arrangements, such as shown in FIG. 3.

This dual power transmission/communication system has a variety of potential applications. It can be applied to power and/or communicate with recording sensors deep in an oil well where there may be tens of thousands of feet of drill pipe. Acoustic fiber wire can be suspended or otherwise provided through the drill pipe.

A drill pipe may contain viscous liquid(s), but the preferred acoustic fiber of the present invention can still function when submerged. Such liquids will typically have a sound speed lower than that of the acoustic fiber cladding, and so it is preferable that the signal remains trapped in within the core of the acoustic-fiber waveguide. Using a metal-over-metal acoustic fiber only to traverse relatively short submerged distances, such as for short work-arounds, will minimize any leakage effect into surrounding liquid. Such leakage into surrounding liquids may have some, albeit relatively small, attenuation on power and signal transmission.

### Power and Signal Transmission Using Fluid Filled Waveguides

In another embodiment of the invention, a similar dual power and signal transmission system to that described above can be formed using fluid-filled wave guides. Fluid filled hydraulic waveguides advantageously already exist in some oil well systems in the form of hydraulic lines. Since the speed of sound in liquids is about 4 times slower than the speed of sound in a metal enclosure, a hydraulic line can be advantageously used as an acoustic channel waveguide. The principals, elements, and arrangements delineated for aluminum-clad steel wires, with a few exceptions that will be clear to a person of skill in the art, also apply to liquid core systems, and are incorporated by reference as if fully restated here.

This fluid-filled wave guide system can also be applied with recording sensors deep in oil wells. Such sensors may be located along or at the end of drill pipes, which can stretch for 30,000 feet or more. Hydraulic lines can be suspended and spooled into an environment, such as a drill pipe, containing viscous liquid. Such viscous liquids will typically have sound speeds lower than the cladding so that the signal will remain trapped in the aluminum-clad fiber waveguide.

In an alternative preferred embodiment using fluid-filled wave guides, a transponder along a hydraulic line serves as a secondary receiver/sender 20, while the hydraulic line itself serves as the waveguide 8. The transponder can be used to generate longitudinal waves, such as through a side branch of the hydraulic line or a side wall of the hydraulic line. Arrangements with multiple transponders, potentially arranged on different branches of a hydraulic system, are possible. Transponders or other devices for sending and receiving longitudinal waves through the fluid can be employed as primary sender/receivers 18.

### Acoustic Power and Communication Transmission Through a Surface Via Angled Waves

As mentioned, in drilling and oil well operations, it is often necessary to communicate information (such as sensor data) along a drill pipe string where portions of the well and drill string are not directly accessible via a direct electrical connection. For example, there may be segments that are disjointed and sealed off from each other, making electrical connection between the segments impossible. An alternative aspect of the present invention is therefore an improved means of passing both power and data through drill pipe strings, including strings having blocked off sections, using acoustic waves sent through the pipe itself.

The improved system can simultaneously transmit both digital information and/or power, preferably in both directions, through the wall of a pipe or other analogous substrate using ultrasound from an angle beam probe. The angle beam probe may comprise transducers, such as an ultrasonic piezoelectric transducers.

Similar power communication systems can be implemented using longitudinal waves by using magnetostrictive means as well. Magnetostrictive materials can convert magnetic energy into kinetic energy, and vice versa.

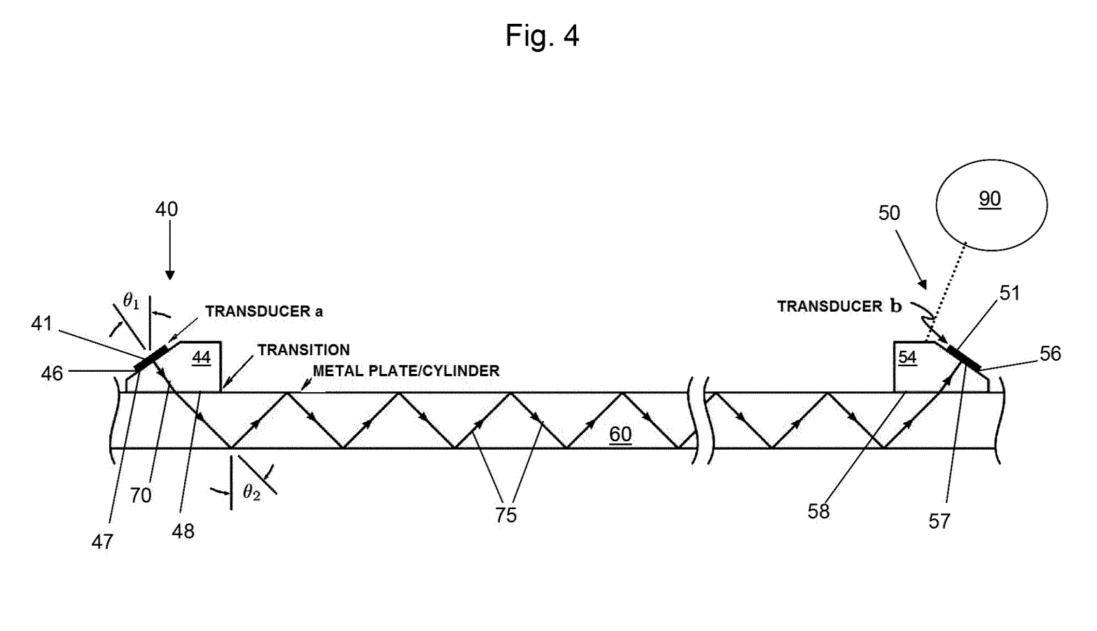

The preferred system shown schematically in FIG. 4 consists of two acoustic wedges 40,50, which may be sending and receiving acoustic wedges. Each acoustic wedge preferably includes a transition wedge 44,54 and a transducer 41,51. Each transducer preferably includes a generally planar face 47,57. Each transition wedge preferably has at least one slanted edge 46,56. The planar face of a transducer may be fixed to a slanted edge to fix and orient the planar face at a given angle. The angle of the slanted edge, or other aspects of the shape of the transition wedges, may be selected in order to support a transducer at a selected angle. A transition wedge may resemble a rectangular solid with a corner sliced off to provide the slanted edge, although the invention is not limited to any particular shape. Typically a bottom side of each transition wedge 44,54 is engaged to the substrate 60. The interface 48,58 of the substrate and the wedges should be as seamless as possible for sending and receiving wave energy. A signal sender/receiver, typically a transducer 41,51, is fixed to a slanted edge on the transition wedge so that a flat face of the transducer is at an intermediate angle with regard to the plane of the substrate 75 at the interface 48,58. The acoustic wedges may also be triangles or other shapes. Various arrangements to provide transducers at an angle with regard to the substrate are within the scope and spirit of the invention.

In one embodiment a surface transducer a 41 is located above ground, and a second transducer b 51 is located underground.

The first acoustic wedge 40 sends longitudinal waves 70 launched by transmitting transducer a 41 through a transition block or wedge 44 into a plate or cylindrical shell 60 (e.g., pipe) at an angle such that only transverse (shear) waves 75 are produced in the plate/shell 60. The launch angle in the wedge 40,50 is selected such that it is between the first and second critical angles, so that substantially only shear waves will be produced in the wall 60. These shear waves 75 propagate down the wall 60 to a second acoustic wedge 50 which is angled such that the received shear waves 75 are converted back into longitudinal waves 70 within the transition wedge 54. The longitudinal waves 70 are then captured by the second receiving acoustic transducer b 51. Sending and receiving transducers may be functionally the same or different. In one embodiment above-ground sending 41 and below-ground receiving 51 transducers are essentially the same other than their positions in the system. In some embodiments both sending and receiving transducers send and receive acoustic wave signals.

A portion of the acoustic energy captured by the receiving transducer b 51 can be harvested to produce electric energy in order to power sensors 90 or other devices 90 located in the same region as the second acoustic wedge 50 and transducer b 51. The data generated by the sensors 90 near “receiving” transducer b may be sent back to the first “sending” transducer a 41. The data may be sent back digitally from transducer b along a wall 60 to transducer a 41, where the data may be properly stored, displayed, or retransmitted. Data from the vicinity of transducer b 51 may also be sent elsewhere, and by other known methods. Data may also be sent back using shear waves using the method above in the reverse direction.

It is important to select a suitable angle for the transducers 41,51 so that longitudinal waves 70 emitted by an emitting transducer are converted to transverse/shear waves 75 at the substrate 60. This is achieved by selecting launch angles in the wedges 40,50 which are between the first and second critical angles, so that only or substantially only shear waves will be produced in the wall 60.

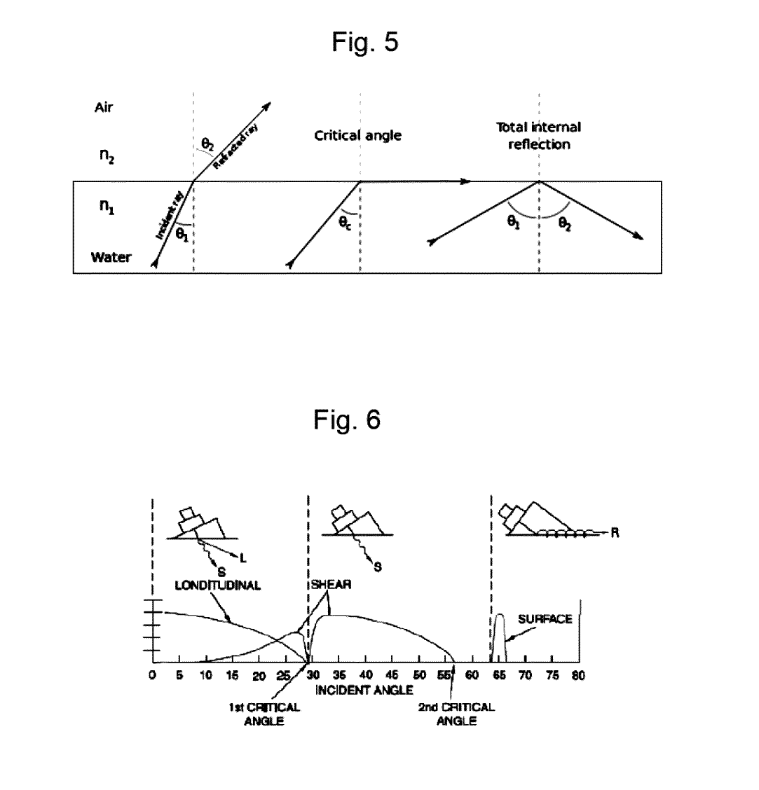

FIG. 5 is a background illustration and equation to help explain the concept of critical angles.

The critical angle is the angle of incidence above which total internal reflection occurs. The angle of incidence is typically measured with respect to the normal at the refractive boundary. Total internal reflection occurs when a propagating wave strikes a medium boundary at an angle larger than a particular critical angle with respect to the normal to the surface. If the refractive index is lower on the other side of the boundary and the incident angle is greater than the critical angle, the wave cannot pass through and is entirely reflected. This is particularly common as an optical phenomenon, where light waves are involved, but it occurs with other types of waves, such as electromagnetic waves in or sound waves.

When a wave crosses a boundary between materials with different refractive indices, the wave will be partially refracted at the boundary surface, and partially reflected. However, if the angle of incidence is greater than the critical angle—if the direction of propagation or ray is closer to being parallel to the boundary —then the wave will not cross the boundary and instead be totally reflected back internally. This can only occur where the wave travels from a medium with a higher refractive index to one with a lower refractive index. For example, it will occur with light when passing from glass to air, but not when passing from air to glass.

Consider a light ray passing from glass into air or. The light emanating from the interface is bent towards the glass. When the incident angle is increased sufficiently, the transmitted angle (in air) reaches 90 degrees. It is at this point no light is transmitted into air. The critical angle θ_{critical} is given by Snell's law. FIG. 5 Illustrates an analogous relationship with a ray of light passing from water into air.

FIG. 6 shows the relationship between the incident angle of the angular longitudinal wave and the relative amplitudes of the refracted and/or mode converted longitudinal, shear, and surface waves that can be produced in the substrate. The method of the invention makes use of the strong shear waves which can be created by using the proper incident angle between the first and second critical angles.

Using Snell's law, the refraction angles (e.g. angles θ₁ and θ₂ in FIG. 4) are determined from:

$$\frac{sin {θ}_{1 Longitudinal}}{{V}_{1 Longitudinal}} = \frac{sin {θ}_{2 Shear}}{{V}_{2 Shear}} = \frac{sin {θ}_{2 Longitudinal}}{{V}_{2 Longitudinal}} = \frac{sin {θ}_{1 Shear}}{{V}_{1 Shear}} .$$

To produce only a shear wave in the plate/shell/pipe 60, the longitudinal launch angle θ_{1Longitudinal} has to be between the first and second critical angles, which will be produced as long as the longitudinal wave in the launch material has a sound speed less than the shear wave speed of the steel:

$$arcsin ( \frac{{V}_{1 Longitudinal}}{{V}_{2 Longitudinal}} ) < {θ}_{1 Longitudinal} < arcsin ( \frac{{V}_{1 Longitudinal}}{{V}_{2 Shear}} )$$

For example, a preferred launch material is acrylic (which may be Perspex), which has a longitudinal wave speed of V_{1Longitudinal acrylic}=2,730 m/s. The first critical launch angle is found by setting θ_{2Longitudinal} to 90°, giving the first critical angle:

$$sin {θ}_{1 LongitudinalFirstCritical} = \frac{{V}_{1 Longitudinal}}{{V}_{2 Longitudinal}}$$

and the second critical launch angle is found by setting θ₂ₛₕₑₐᵣ to 90°, giving the second critical angle

$$sin {θ}_{1 LongitudinalSecondCritical} = \frac{{V}_{1 Longitudinal}}{{V}_{2 Shear}}$$

If, for example, the wall is made of steel with a shear wave speed of V₂ₛₕₑₐᵣ=3,250 m/s, and a longitudinal wave speed of V_{2Longitudinal}=6,100 m/s, then these angles are:

$${θ}_{1 LongitudinalFirstCritical} = arcsin ( \frac{{V}_{1 Longitudinal}}{{V}_{2 Longitudinal}} ) = arcsin ( 2 , 730 / 6100 )$$

$$\begin{matrix}{θ}_{LongitudinalSecondCritical} = arcsin ( \frac{{V}_{1 Longitudinal}}{{V}_{2 Shear}} ) \\ = arcsin ( 2 , 730 / 3250 ) \\ = 57.11 °\end{matrix}$$

Another material that can be used for higher temperature applications is Teflon, with a longitudinal wave speed of 1,372 m/s, and corresponding first and second critical angles of 13.46 degrees and 24.96 degrees, respectively.

So, for θ_{1Longitudinal First Critical}<θ₁<θ_{1Longitudinal Second Critical}, only shear waves at an angle θ_{2Shear} will be present in the communications channel. In addition, this system can also be adjusted by launching pure shear waves at angle θ_{1Shear} using a shear wave transducer in addition to or instead of the above arrangement starting with angled longitudinal waves. Note that there will also be two waves generated in at least the transmitting wedge 44,54, due to reflection, θ_{1Longitudinal} and θ_{1Shear}. These reflected waves are either scattered or absorbed by the other wall of the wedge.

The principles of this invention can be used with various types of plates, tubes, pipes, and similar substrates which are capable of propagating shear waves. While the launching of shear waves for sensor an probing purposes is known, the use of angle beam probes to send acoustic waves to form an acoustic-electric channel to transmit power and send digital communication signals is novel.

Many different channel modulation techniques are suitable for this invention. Non-limiting examples include traditional single-carrier modulations such as amplitude modulation (AM), frequency modulation (FM), ON-OFF Keying (OOK), amplitude-shift keying (ASK), phase-shift keying (PSK), differential phase-shift keying (DPSK), frequency-shift keying (FSK) and quadrature amplitude modulation (QAM).

Multi-carrier modulations such as orthogonal frequency-division multiplexing can also be used and will, in general, provide higher data rates for the channel. Multi-carrier techniques offer the ability to optimize the transmission for the specific transfer function that the channel presents though the use of bit loading. In bit loading each subcarrier uses a modulation type that provides the highest data rate given the signal-to-noise ratio (SNR) of that particular subcarrier channel. Multi-carrier techniques can instead or in addition include power loading, in which the transmit power of each subcarrier is also adjusted to optimize the data throughput over all subcarriers given an overall power budget.

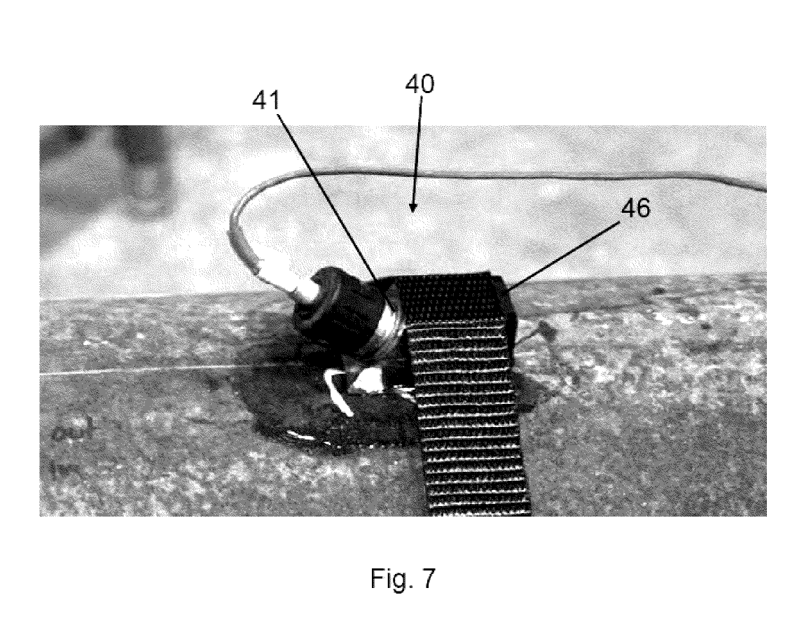

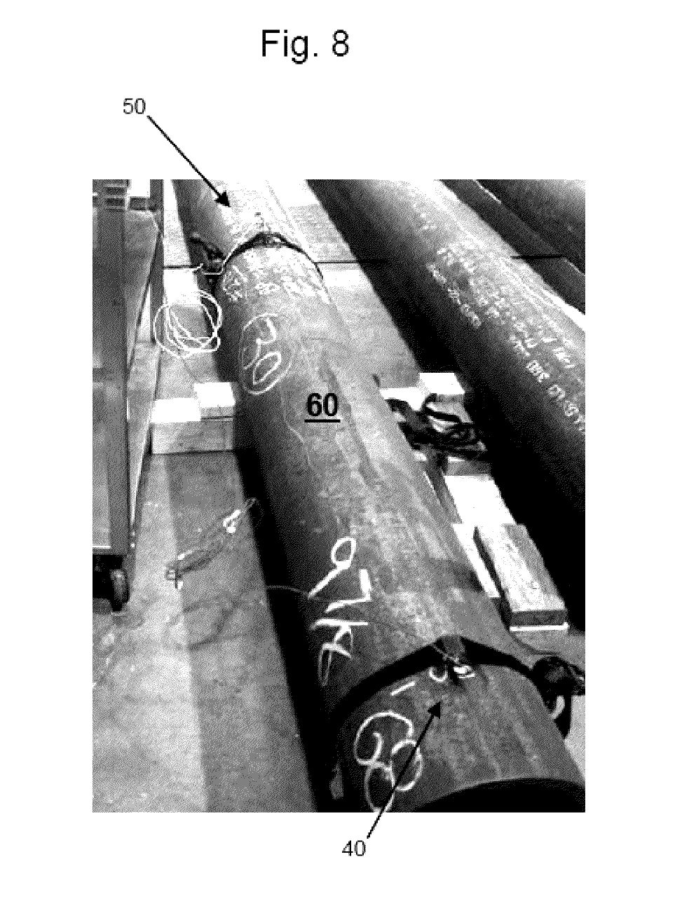

FIG. 7 shows is a side view of an exemplary acoustic wedge 40 mounted on a 9⅞″ diameter, 0.7 inch thick steel pipe substrate 60. The arrangement includes a transition wedge 46 and a mounted transducer 41. FIG. 8 shows a section of the same pipe with a pair of acoustic wedges 40,50 mounted thereon for use with the invention.

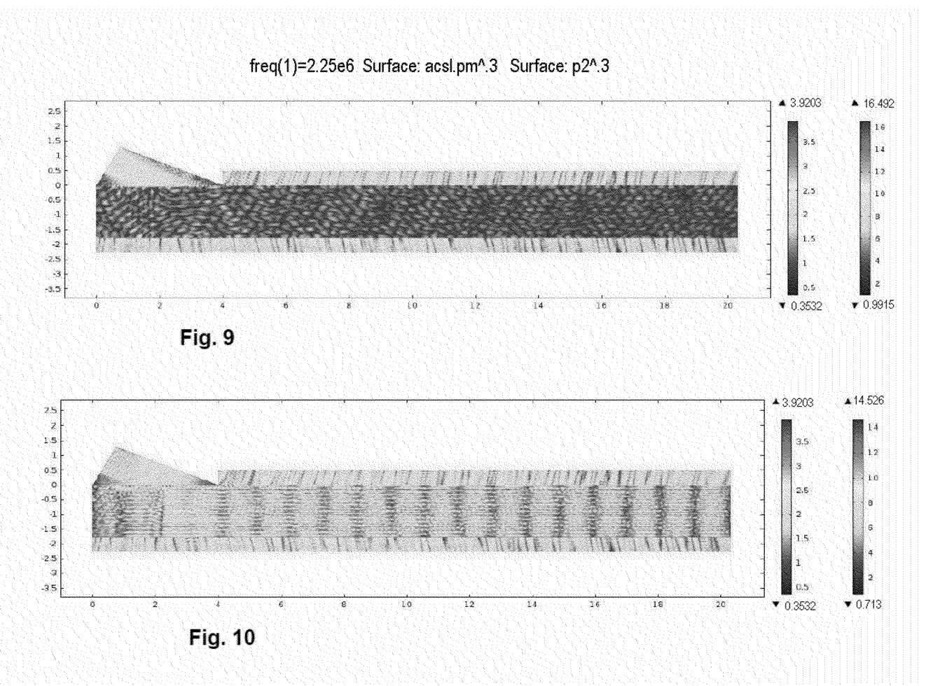

FIGS. 8 and 9 are computer generated images showing shear wave propagation. The shear waves are launched via a longitudinal wave sent through an acrylic wedge 44 into a 0.7 inch (17.78 mm) thick submerged steel plate substrate 60. In both figures the Wedge 44 is the triangle at top left, the steel plate substrate 60 in the thick horizontal line at the center with water 62 above and below it. FIG. 8 shows the (pressure)̂0.3 in the beam and wedge. FIG. 9 shows the xy deviatoric stress (the log of the Von Mises stress) in the beam and wedge. Both figures show the (pressure)̂0.3 in the water.

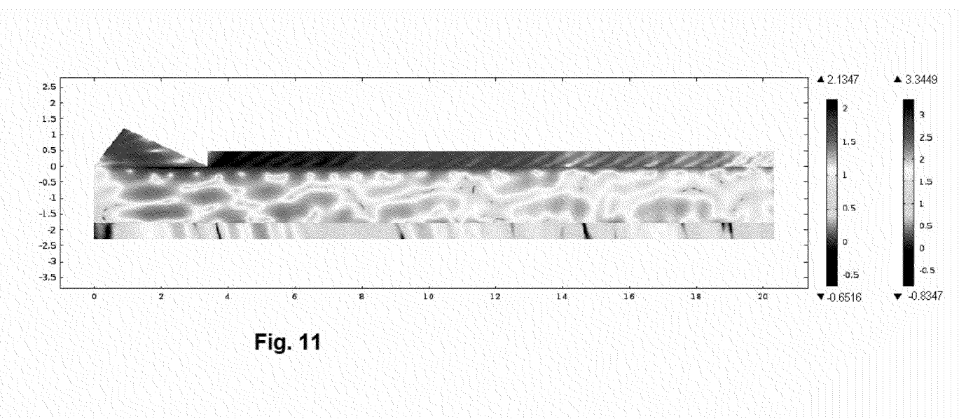

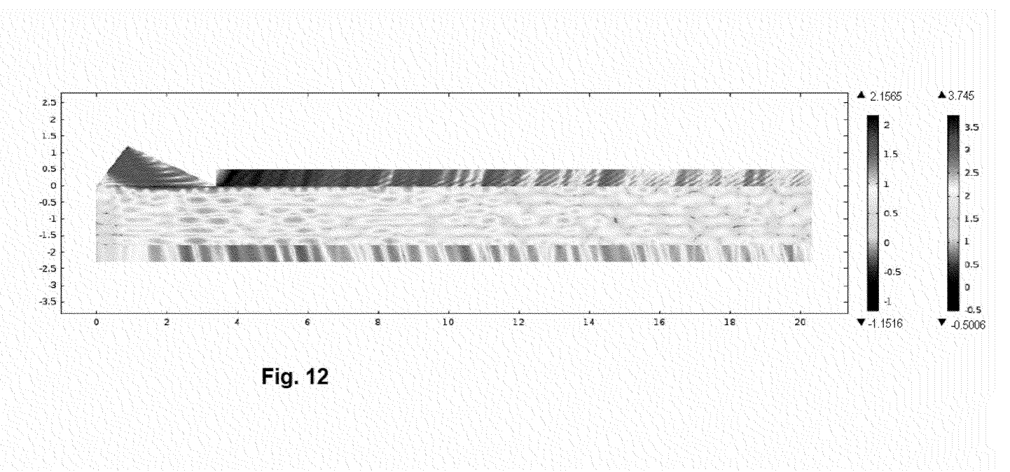

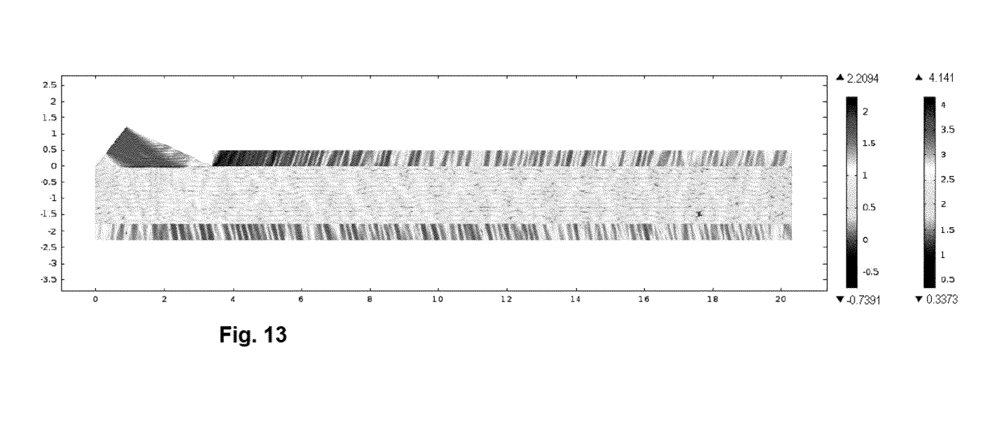

FIGS. 10-12 are plots of the log of the amplitude of the pressure in the steel substrate 60 and acrylic wedge 44 at three different frequencies: 0.5 (FIG. 10), 1.0 (FIGS. 11), and 2.25 (FIG. 12) MHz. It makes the standing wave in the solids more clear. Also the beam is now 8″ instead of 3″.

The present invention includes both methods and apparatus based on the above disclosures.

While a specific embodiment of the invention has been shown and described in detail to illustrate the application of the principles of the invention, it will be understood that the invention may be embodied otherwise without departing from such principles.

What is claimed is:

1. A method of powering and controlling sensors at a distance using acoustic wave energy, the method comprising:
providing a transmission arrangement comprising an acoustic signal generator;
providing a receiving arraignment comprising an acoustic signal receiver;
providing a least one sensor which is electrically coupled to the signal receiver;
providing a waveguide spanning between and engaged to the signal generator and the signal receiver;
generating an acoustical wave comprising a control signal with the signal generator, the acoustical wave having sufficient strength to provide operating power to the sensor, and transmitting the acoustical wave from the signal generator to the signal receiver through the waveguide;
receiving the acoustical wave at the signal receiver, and converting the acoustical wave into an electrical current comprising a converted control signal;
using the electrical current to power the sensor; and
using the converted control signal to control the sensor.

2. The method of powering and controlling sensors at a distance using acoustic wave energy of claim 1, wherein the waveguide comprises a core region, and a cladding region radially surrounding the core region and having a different material composition than the core region.

3. The method of powering and controlling sensors at a distance using acoustic wave energy of claim 2, wherein the core comprises steel wire, and the cladding comprises aluminum.

4. The method of powering and controlling sensors at a distance using acoustic wave energy of claim 2, wherein the longitudinal wave velocity of the cladding is greater than the longitudinal wave velocity of the core.

5. The method of powering and controlling sensors at a distance using acoustic wave energy of claim 2, wherein the longitudinal wave velocity of the cladding is greater than the longitudinal wave velocity of the core; and
wherein during transmission of the acoustical wave from the signal generator to the signal receiver through the waveguide, the acoustical wave substantially reflects off of the wave guide cladding to thereby substantially maintain the acoustical wave in the core.

6. The method of powering and controlling sensors at a distance using acoustic wave energy of claim 1, wherein the signal generator and signal receiver both comprise piezoelectric transducers;
wherein the signal generator piezoelectric transducer generates an acoustical wave comprising a control signal in response to electrical current applied to it; and
wherein the signal receiver piezoelectric transducer receives at least part of the acoustical wave, and converts at least a portion of the received acoustical wave into an electrical current which is then used to power and control the sensor.

7. The method of powering and controlling sensors at a distance using acoustic wave energy of claim 6, wherein the sensor is powered exclusively using electricity generated by the signal receiver piezoelectric transducer.

8. The method of powering and controlling sensors at a distance using acoustic wave energy of claim 1, wherein at least one of the signal generator and the signal receiver comprise a magnetorestrictive element.

9. The method of powering and controlling sensors at a distance using acoustic wave energy of claim 1, wherein the transmission arrangement is above ground;
wherein the receiving arraignment and the sensor are below ground; and
wherein acoustical waves transmitted from the signal generator to the signal receiver through the waveguide are used to power and control the sensor below ground.

10. The method of powering and controlling sensors at a distance using acoustic wave energy of claim 1, wherein the acoustical wave is modulated to create the control signal.

11. The method of powering and controlling sensors at a distance using acoustic wave energy of claim 1, wherein the waveguide is a fluid filled waveguide comprising a liquid core region radially surrounded by solid cladding; and
wherein the acoustical wave propagates through the liquid core region of the waveguide.

12. A method of transmitting at least one of power and signals along a substrate using angle beam probes, the method comprising:
providing a transmitting acoustic wedge and a receiving acoustic wedge spaced apart on a substrate and coupled to the substrate at respective interfaces;
wherein each acoustic wedge comprises a transition wedge and a transducer comprising a transducer face wherein the transducer is coupled to the transition wedge, and wherein a transducer face of each transducer is normal to an angle θ with regard to the substrate at the respective interface;
wherein the transducer face of the transmitting transducer of the transmitting acoustic wedge is normal to an angle θ₁ with respect to the respective interface with the substrate, the angle θ₁ being between first and second critical angles such that longitudinal waves produced by the transmitting transducer are substantially converted into shear waves in the substrate;
the method further comprising producing longitudinal waves at angle θ₁ at the transmitting transducer;
the longitudinal waves producing substantially only shear waves in the substrate, and the shear waves propagating through the substrate until reaching the interface between the substrate and the receiving acoustic wedge;
energy from the shear waves providing acoustical wave energy which reaches the receiving transducer of the receiving acoustic wedge; and
the receiving transducer converting at least a portion of said acoustical wave energy into electrical energy.

13. The method of claim 12, further comprising:
shear waves traveling through the substrate and reaching the receiving acoustic wedge, and the shear waves substantially converting to longitudinal waves at the receiving acoustic wedge; and
the receiving transducer of the receiving acoustic wedge receiving at least a portion of the longitudinal waves and converting at least a portion of said longitudinal waves into electrical energy.

14. The method of claim 12, wherein the substrate comprises steel and the transition wedges comprise acrylic.

15. The method of claim 12, wherein the substrate is a metal pipe.

16. The method of claim 12, wherein the method is used to transmit power to operate a sensor in the vicinity of the receiving acoustic wedge, the method further comprising using electrical energy created by the receiving transducer to power a sensor.

17. The method of claim 12, wherein signals are also sent in the reverse direction from the receiving acoustic wedge to the transmitting acoustic wedge.

18. The method of claim 12, wherein signals are also sent in the reverse direction from the receiving acoustic wedge to the transmitting acoustic wedge,
wherein the step of sending signals in the reverse direction comprises the receiving transducer generating longitudinal waves at an angle with respect to the respective interface with the substrate, the angle being between first and second critical angles such that longitudinal waves produced by the receiving transducer are substantially converted into shear waves in the substrate, and the shear waves propagating through the substrate 60 to the receiving acoustic wedge.

19. The method of claim 12, wherein the substrate comprises pipe in an oil well, wherein the receiving transducer produces electrical energy for an underground sensor 90, and wherein the electrical energy is used to power the sensor.

20. The method of claim 12, wherein the transition wedge of the transmitting acoustic wedge has a generally slanted edge which is normal to an angle θ₁ with respect to the respective interface with the substrate;
the transducer face of the transmitting transducer being positioned on the slanted edge;
wherein the angle θ₁ is between first and second critical angles such that longitudinal waves produced by the transmitting transducer are substantially converted into shear waves in the substrate.

21. The method of claim 12, wherein the angle θ₁ between first and second critical angles is the longitudinal wave launch angle θ_{1Longitudinal},
the method comprising the step of determining θ_{1Longitudinal} using the relationship:
$$arcsin ( \frac{{V}_{1 Longitudinal}}{{V}_{2 Longitudinal}} ) < {θ}_{1 Longitudinal} < arcsin ( \frac{{V}_{1 Longitudinal}}{{V}_{Shear}} )$$
wherein V_{1Longitudinal} is the longitudinal wave speed in the transition wedge, V_{2Longitudinal} is the longitudinal wave speed in the substrate, and V₂ₛₕₑₐᵣ is the shear wave speed of the substrate.
